(19) United States
(12) Patent Application Publication
(10) Pub. No.: US 2025/0028781 A1
(43) Pub. Date: Jan. 23, 2025

(54) Sub-Graph Isomorphism

(71) Applicant: Mastercard International Incorporation, New York, NY (US)

(72) Inventor: Nicola MARIELLA, Oranmore (IE)

(21) Appl. No.: 18/714,630

(22) PCT Filed: Oct. 31, 2022
(86) PCT No.: PCT/US2022/048373

§ 371 Date: May 30, 2024

(30) Foreign Application Priority Data
Dec. 1, 2021 (GB) 2117369.5

(51) Int. Cl. G06F 17/11

(52) U.S. Cl. CPC G06F 17/11

(57) ABSTRACT

A sub-graph isomorphism determination method comprising the steps of: determining, by the classical computer, a first adjacency matrix of a first graph and a second adjacency matrix of a second graph; wherein the first graph comprises a greater number of vertices than the second graph; determining, by the classical computer, an objective optimization problem subject to one or more constraints; wherein an objective of the objective optimization problem is to determine a partial permutation matrix; determining, by the classical computer, a QUBO matrix suitable for implementing the objective optimization problem; solving, by a quantum computer, a QUBO formulation including the QUBO matrix, thereby providing the partial permutation matrix; applying, by the classical computer, the partial permutation matrix to the first adjacency matrix, thereby producing a partially permuted first adjacency matrix; wherein the partially permuted first adjacency matrix corresponds to a sub-graph of the first graph that is isomorphic with the second graph.

### CROSS REFERENCE TO RELATED APPLICATION

This application claims the benefit of United Kingdom Patent Application No. 2117369.5, which was filed on Dec. 1, 2021, the entire contents of which are hereby incorporated by reference for all purposes.

### TECHNICAL FIELD

The present disclosure relates to quantum computing. In particular, the present disclosure relates to a computer-implemented method and corresponding computing device for determining the existence of sub-graph isomorphism, and more particularly for determining whether an input data matches an existing data.

### BACKGROUND

Quantum computers exploit the quantum superposition characteristics of particles to determine the optimal solution to complex non-linear problems. Unlike classical computers where a classical memory bit will take either a value of “1” or a value of “0”; in a quantum computer, a quantum bit or “qubit” may take a value of “1”, “0” or a superposition of “1” and “0”. By resolving the value of a plurality of qubits, the quantum computer can determine the minimum energy state of the qubits and so determine in one computation cycle the optimum solution to a given problem.

In order to exploit the processing efficiency of a quantum computer to solve a complex real world problem, the real world problem and variable may need to be expressed to the quantum computer in a resolvable manner. Determining how to express the problem and variables may be a computationally expensive task which may require more processing cycles than would be needed to solve the problem using a traditional iterative method.

Sub-graph isomorphism is where a first graph and a second graph are given as an input, and it is determined whether the first graph contains a sub-graph that is isomorphic to the second graph. This sub-graph isomorphism problem is NP-complete and finding a solution is inherently difficult.

The present disclosure has been devised to mitigate or overcome at least some of the above-mentioned problems.

### SUMMARY OF THE DISCLOSURE

In accordance with the present disclosure, there is provided a sub-graph isomorphism determination method comprising the steps of: determining, by the classical computer, a first adjacency matrix of a first graph and a second adjacency matrix of a second graph; wherein the first graph comprises a greater number of vertices than the second graph; determining, by the classical computer, an objective optimization problem subject to one or more constraints; wherein an objective of the objective optimization problem is to determine a partial permutation matrix; determining, by the classical computer, a QUBO matrix suitable for implementing the objective optimization problem; solving, by a quantum computer, a QUBO formulation including the QUBO matrix, thereby providing the partial permutation matrix; applying, by the classical computer, the partial permutation matrix to the first adjacency matrix, thereby producing a partially permuted first adjacency matrix; wherein the partially permuted first adjacency matrix corresponds to a sub-graph of the first graph that is isomorphic with the second graph.

Preferably, the one or more constraints includes: an orthogonality constraint configured to restrict the partial permutation matrix to being an orthogonal matrix; and a binary constraint configured to restrict the entries of the partial permutation matrix to a 0 or a 1.

Preferably, the objective optimization problem is based on a loss function.

Preferably, the loss function is based on a Frobenius norm.

Preferably, the QUBO matrix comprises: converting the objective optimization problem into an equivalent optimization problem; transforming the one or more constraints into one or more corresponding penalty terms; and implementing the equivalent optimization problem and penalty terms as a QUBO problem.

Preferably, converting the objective optimization problem into an equivalent optimization problem comprises: expanding the Frobenius norm subject to the constraints, thereby generating a first component and a second component; expanding the first component into a first vectorization operator formulation; expanding the second component into a second vectorization operator formulation; and generating the equivalent optimization problem based on the first and second vectorization operator formulations.

Preferably, the vectorization operator formulations comprise one or more vectorization operator configured to linearly transform a matrix into a column vector.

Preferably, the solution is obtained when the loss function vanishes.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the disclosure will now be described, by way of example only, with reference to the accompanying drawings, in which:

FIG. 1 is a computing system;

FIG. 2 is a method for determining whether a sub-graph of a first graph is isomorphic with a second graph;

FIG. 3 is a method for determining a QUBO matrix;

FIG. 4a is an example first subgraph section;

FIG. 4b is an example second subgraph section;

FIG. 5 is a method for determining whether an input data matches an existing data; and

FIG. 6 is a method for determining a common induced subgraph;

FIG. 7a is an example first graph; and

FIG. 7b is an example second graph.

### DETAILED DESCRIPTION

### Quadratic Unconstrained Binary Optimisation

A real world problem may be formulated as an objective optimisation problem subject to a number of constraints. The objective optimisation problem may be a combinatorial problem that fits the QUBO (Quadratic Unconstrained Binary Optimisation) form. A QUBO problem is a form of discrete optimisation problems that involves finding a set x of N binary variables {xᵢ} that minimises the objective problem, defined as:

$$E ( x ) = {x}^{T} Q x$$

Where Q is an N×N matrix comprising elements qᵢⱼ that is characteristic of the real world problem, wherein elements qᵢⱼ preferably represent a weight (or a coefficient). Q may be in either a symmetric or upper triangular form. The x term represents a vector having a range of binary values, 0 or 1, i.e. x∈{0, 1}. The diagonal terms of Q represent linear terms whilst the off-diagonal terms of Q represent quadratic terms. Accordingly, the objective problem is defined by the above equation.

A significant application of QUBO emerges from its equivalence to the Ising model, wherein the energy of a configuration of the Ising model is given by a Hamiltonian function defined by a first term and a second term as:

$$H ( σ ) = - {\sum }_{〈 ij 〉} {J}_{i j} {σ}_{i} {σ}_{j} - μ {\sum }_{j} {h}_{j} {σ}_{j}$$

The first term −Σ₍ᵢⱼ₎Jᵢⱼσᵢσⱼ corresponds to an interaction (or coupling strength) Jᵢⱼ between a first site i and a second site j. The first site may have a first spin, σᵢ and the second site may have a second spin, σⱼ, each spin having a value of +1 or −1, i.e. σ∈{−1, 1}ⁿ. The notation [symbol] ij [symbol] indicates that the first site and the second site are nearest neighbours, wherein each pair of sites is counted once. The second term, −μΣⱼhⱼσⱼ represents an interaction between the system and an external bias hⱼ, for example a transverse magnetic field. The external bias is generated by the bias device 144. Therefore, hⱼ is a strength of the magnetic field interacting with the site j having a spin σⱼ. Importantly, interaction Jᵢⱼ and bias hⱼ are programmable parameters that may be adjusted. The Ising model may be translated into a QUBO problem, or vice versa, by defining xᵢ=(σⱼ+1)/2. Accordingly, the QUBO problem advantageously maps to the Ising model which, following the quantum annealing process, leads to a ground state solution corresponding to a minimised solution of the real world problem. Accordingly, the objective problem is implemented by the quantum computing unit 106 as a Hamiltonian with adjustable parameters Jᵢⱼ and hⱼ. Importantly, a length of vector x corresponds to the number N of qubits required to represent the objective optimisation problem.

The coupling interaction is implemented by the coupling devices 142 which preferably couples (or entangles) a first qubit with a second qubit. The coupling device or devices 142 may be, for example, a superconducting loop. The coupling between the first qubit and the second qubit is either ferromagnetic or anti-ferromagnetic as the qubits interact via their respective magnetic fluxes. A change in flux of the first qubit will affect the flux of the second qubit. If the coupling is ferromagnetic (i.e. Jᵢⱼ>0), it is energetically favourable for a change in flux of the first qubit to produce a similar change in the flux of the second qubit. Accordingly, a clockwise superconducting current in the first qubit will cause a clockwise superconducting current in the second qubit to be more energetically favourable than a counter-clockwise superconducting current. In this case, the first qubit and the second qubit will tend towards the 0 state. If the coupling is anti-ferromagnetic (i.e. Jᵢⱼ<0), it is energetically favourable for a change in the flux of the first qubit to cause an opposite effect in the flux of the second qubit. Accordingly, a clockwise superconducting current in the first qubit will cause a counter-clockwise superconducting current in the second qubit to be more energetically favourable than a clockwise superconducting current. In this case, the first qubit will tend towards the 0 state and the second qubit will tend towards the 1 state.

Accordingly, the QUBO framework may express a real world problem as an energy function which can be provided to the quantum computer. The variables identified in relation to the real world problem are mapped to the variables of the QUBO energy function. The QUBO energy function may be thought of as a matrix wherein each value in the matrix expresses the relationship between two different qubits in the quantum computer. For simplicity some embodiments herein may be described in terms of a problem expressed in a two-dimensional QUBO matrix. However, other embodiments may express problems in terms of three or more dimensions. Once the energy function has been input to the quantum computer, the physical properties of the quantum computer will cause the function to resolve to a minimum value landscape which may be output as an optimisation of the result.

The present disclosure relates to a computer-implemented method

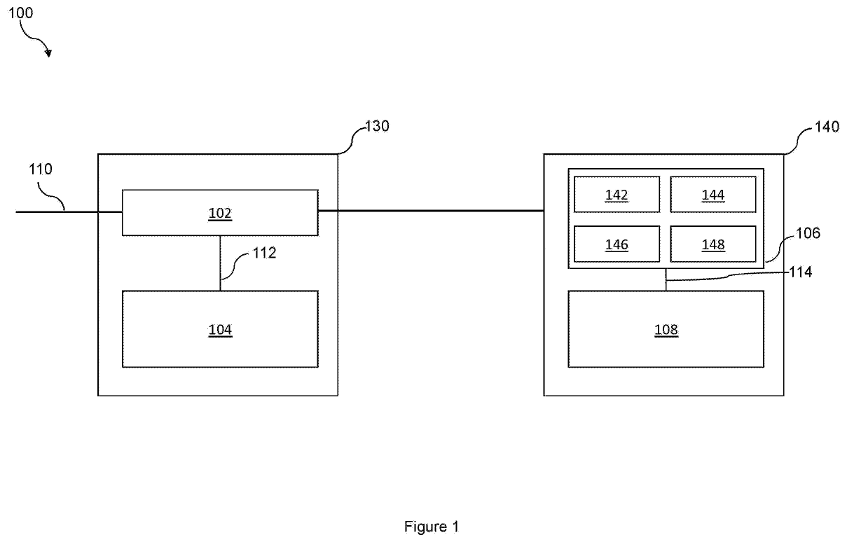

FIG. 1 shows a computing system 100 comprising a classical computer 130. The classical computer 130 comprises a CPU 102 coupled to provide transactions to, and receive transactions from, a conventional memory 104 by means of a memory interface 112. Input information may be received by the CPU from an interface 110. Output information may be provided by the CPU to the interface 110. The classical computer 130 may further comprise additional classical computing elements as known in the art (not shown).

The classical computer 130 is coupled to a quantum computer 140. In some embodiments, the quantum computer is a quantum annealer. The skilled person will appreciate that the quantum computer may be any device suitable for solving QUBO problems.

The quantum computer 140 comprises a quantum computing unit 106 and a quantum memory unit 108, a plurality of coupling devices 142, a bias device 144, and a state determination device 146. The quantum computing unit 106 comprises a number N of qubits 148. The qubits 148 may be for example, superconducting flux devices 148 having a circulating current. For example, the superconducting flux devices 148 may comprise a loop of superconducting material interrupted by at least one Josephson junction, as is known in the art. Further qubit implementations may be envisaged. The quantum computing unit 106 is configured to provide transactions to, and receive transactions from, the quantum memory unit 108 by means of a memory interface 114. A “state” of the quantum computing unit 106 corresponds to the respective state of all of the N qubits. An example state of a qubit is a 0 state. The 0 state may correspond to, for example, a clockwise current around the superconducting flux devices 148 which may induce a downward magnetic field. A counter clockwise current around the superconducting flux devices may induce an upwards magnetic field which references a state 1. The state of the quantum computing unit 106 may be described by a bit string having a length N. Thus, there are 2^{N} possible configurations for the state of the quantum computing unit 106. The quantum computer 140 is a quantum annealer. Other quantum computing models may be envisaged.

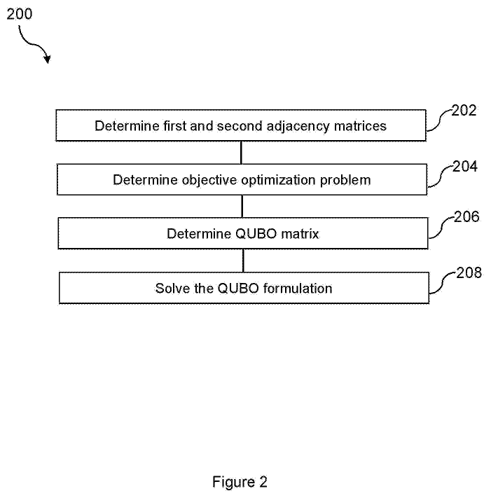

The following section provides an iterative method 200, according to FIG. 2, for determining whether a sub-graph of a first graph is isomorphic with a second graph.

### Adjacency Matrix Representation

A directed graph C=(V_{C}, E_{C}) may be defined as a tuple containing a vertices set V_{C} and an edges set E_{C}. The vertices set comprises vertices i, j of the directed graph C. The elements of the edges set E_{C} are pairs of vertices (i,j)∈E_{C}, with i, j∈V_{C}, corresponding to an edge connecting i→j∈C.

In a general case, an adjacency matrix M of the directed graph C having n vertices is an n by n matrix having matrix elements M_{i,j}, wherein i and j are the vertices of the directed graph C. The matrix elements M_{i,j} are determined such that matrix element M_{i,j} is 1 if a directional edge connects vertex i to vertex j, and is 0 if no directional edge connects vertex i to vertex j. That is, the matrix element M_{i,j} is one if (i,j) is an edge of the edges set E_{C}, such that (i,j)∈E_{C}:

$${M}_{i , j} = \{ \begin{matrix}1 , & \{ i , j \} ∈ {E}_{C} \\ 0 , & otherwise\end{matrix}$$

The adjacency matrix M may be represented as:

$$M = {\sum }_{i , j} {M}_{i , j} \vert i j \vert$$

In a first step 202 of the method 200, a first adjacency matrix A and a second adjacency matrix B are determined according to the above adjacency matrix representation.

In the present example, the method 200 is applied to a first graph S=(V_{S}, E_{S}) and a second graph R=(V_{R}, E_{R}). The graph S comprises a larger number of vertices than the second graph R. If an injective edge-preserving mapping exists from the vertices of the second graph R to the vertices of the first graph S, then the second graph R is isomorphic with a sub-graph S^{S} of the first graph S. The skilled person will understand that the sub-graph S^{S} is a graph having vertices that are a subset of the vertices of the graph S, determined by the image of the mapping.

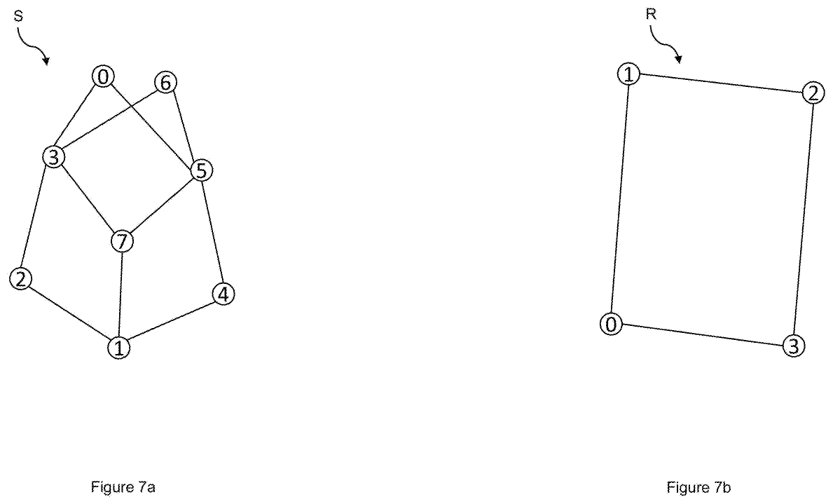

The first graph S is depicted in FIG. 7a and comprises a first set of vertices V_{S}, wherein V_{S}={s₁, s₂, . . . , sₙ} and n is the total number of vertices in the first set of vertices V_{S}. The vertices of the first set of vertices V_{S} are connected via a first set of edges E_{S}, wherein the edges are directed.

The second graph R is depicted in FIG. 7b and comprises a second set of vertices V_{R}, wherein V_{R}={r₁, r₂, . . . , rₘ} and m is the total number of vertices in the second set of vertices, such that m<n. The vertices of the second set of vertices V_{R} are connected via a second set of edges E_{R}, wherein the edges are directed.

In the present example, first graph S comprises 8 vertices (such that n=8) and the second graph R comprises 4 vertices (such that m=4). The first set of vertices is V_{S}={0, 1, 2, 3, 4, 5, 6, 7} and the second set of vertices is V_{T}={0, 1, 2, 3}.

The first adjacency matrix A corresponds to the first graph S of FIG. 7a and the second adjacency matrix B corresponds to the second graph R of FIG. 7b. In the present example, the adjacency matrices A, B are:

$$A = [ \begin{matrix}0 & 0 & 0 & 1 & 0 & 1 & 0 & 0 \\ 0 & 0 & 1 & 0 & 1 & 0 & 0 & 1 \\ 0 & 1 & 0 & 1 & 0 & 0 & 0 & 0 \\ 1 & 0 & 1 & 0 & 0 & 0 & 1 & 1 \\ 0 & 1 & 0 & 0 & 0 & 1 & 0 & 0 \\ 1 & 0 & 0 & 0 & 1 & 0 & 1 & 1 \\ 0 & 0 & 0 & 1 & 0 & 1 & 0 & 0 \\ 0 & 1 & 0 & 1 & 0 & 1 & 0 & 0\end{matrix} ]$$

$$B = [ \begin{matrix}0 & 1 & 0 & 1 \\ 1 & 0 & 1 & 0 \\ 0 & 1 & 0 & 1 \\ 1 & 0 & 1 & 0\end{matrix} ]$$

At step 204 of the method 200, an objective optimization problem is determined. An objective of the objective optimization problem is to determine a partial permutation matrix P.

The partial permutation matrix P is a matrix which generates a permuted adjacency matrix when applied to an adjacency matrix A, B the permuted adjacency matrix corresponding to a sub-graph. For example, in the present method, when the partial permutation matrix P is applied to the first adjacency matrix A a partially permuted first adjacency matrix is generated which corresponds to a sub-graph of the first graph S. The sub-graph of the first graph S is isomorphic with the second graph R.

The partial permutation matrix P is a m×n matrix composed of a sum of rank one matrices:

$$\begin{matrix}{{P = ( {I}_{m} \vert {O}_{m , n - m} ) \cdot {\sum }_{i = 0}^{n - 1} \vert π ( i ) 〉}_{m} 〈 í \vert}_{n} \\ {{= {\sum }_{i ∈ \{ j ∈ {Ω}_{n} \vert π ( j ) < m \}}^{n - 1} \vert π ( i ) 〉}_{m} 〈 i \vert}_{n} \\ {{= {\sum }_{i = 0}^{m - 1} \vert i 〉}_{m} 〈 {π}^{- 1} ( i ) \vert}_{n}\end{matrix}$$

Wherein: Ωₙ={0, 1, 2, . . . , n−1}; | [symbol] :=eᵢ⁽ⁿ⁾ is the i^{th} column vector of the adjacency matrix on which the permutation matrix P is applied from the standard basis of [symbol] ; n is a member of the symmetric group of degree n, Sₙ¹, such that π∈Sₙ¹; π∈Sₙ¹ is a permutation of the set Ωₙ; Iₘ is the m×n identity matrix having entries of ones; O_{m,n-m} is the m×(n−m) matrix having entries of zeros.

The skilled person will understand that the first adjacency matrix A having n vertices and the second adjacency matrix B having m vertices may be formulated as:

$${A = {\sum }_{i = 0}^{n - 1} \vert j 〉}_{n}$$

$${B = {\sum }_{i = 0}^{m - 1} \vert i 〉}_{m}$$

The partial permutation matrix P comprises a number of properties. The entries of the partial permutation matrix P are binary such that P_{i,j}∈{0,1}= [symbol] . Additionally, PP^{T}=Iₘ wherein Iₘ is the m×n matrix having entries of ones. Furthermore, P^{T}P is a binary diagonal matrix, wherein the diagonal entries of the P^{T}P matrix are in [symbol] . Finally, Tr(P^{T}P)=m. The skilled person will understand that if the first graph S comprises the same number of vertices as the second graph R, such that m=n, then P^{T}P=1, wherein I is the identity. In the case where m=n, P is instead a full permutation matrix and comprises an additional property wherein P^{T}P=I, I being a square matrix having entries of ones such that P is orthogonal and invertible. Since the second graph R comprises a fewer number of vertices than the first graph S, such that m<n, the is the total number of vertices in the second set of vertices, such that m<n the partial permutation matrix P applied to the first adjacency matrix A is:

$${{{{{P {\sum }_{i = 0}^{n - 1} \vert j 〉}_{n} = ( {\sum }_{i = 0}^{m - 1} \vert i 〉}_{m} 〈 {π}^{- 1} ( í ) \vert}_{n} ) {\sum }_{i = 0}^{n - 1} \vert j 〉}_{n} = {\sum }_{i = 0}^{n - 1} \vert í 〉}_{m}$$

Furthermore:

$${P {\sum }_{i = 1}^{n - 1} \vert j 〉}_{n} = P {1}_{n} = {1}_{m}$$

Wherein 1ₙ² is equivalent to Σᵢ|j [symbol] , and denotes an n-dimensional vector having entries of ones.

The set of m×n partial permutation matrices [symbol] may be defined as:

$$= \{ M ∈ ( ) \vert {MM}^{T} = {I}_{m} \}$$

Wherein, with m≤n, [symbol] ( [symbol] ) is the set of m×n matrices in [symbol] , such that the entries are binary.

The skilled person will understand that a conjugacy action of a partial permutation matrix P (also referred to as a partial permutation P) on the n×n first adjacency matrix A results in an m×m partially permuted adjacency matrix PAP^{T} corresponding to a sub-graph S′ of the first graph S. Accordingly, the partially permuted adjacency matrix PAP^{T} may be compared with the m×m second adjacency matrix B. Advantageously, the sub-graph S′ may therefore be compared with the second graph R. In particular, the comparison may be achieved by a matrix norm. In the present example, a Frobenius norm may be selected. The skilled person will appreciate that any norm suitable for the comparison may be selected.

The objective optimization problem is a loss function ƒ(P). The loss function is based on the matrix norm ƒ(P). Following the Frobenius norm, a function ƒ_{A,B}: [symbol] → [symbol] is applied, and the loss function is:

$$f ( P ) = {\vert {PAP}^{T} - B \vert}_{F}^{2}$$

Accordingly, the loss is obtained through a mapping of the form g: [symbol] × [symbol] →[ [symbol] → [symbol] ].

An objective of the present method is to determine a partial permutation matrix P which reduces the loss function ƒ(P) to zero. The skilled person will understand that the second graph R has a non-trivial group of symmetries and consequently, for the same sub-graph S′, a non-unique permutation P is expected. Equivalently, the permutation for a subgraph S′ is unique up to a symmetry of the second graph R.

The partial permutation matrix P is a m×n matrix of binary values, such that matrix entries p_{i,j}∈ [symbol] . In the present example, the m×n matrix is a 4×8 matrix:

$$P = ( \begin{matrix}{p}_{1 , 1} & {p}_{1 , 2} & {p}_{1 , 3} & {p}_{1 , 4} & {p}_{1 , 5} & {p}_{1 , 6} & {p}_{1 , 6} & {p}_{1 , 8} \\ {p}_{1 , 2} & {p}_{2 , 2} & {p}_{2 , 3} & {p}_{2 , 4} & {p}_{2 , 5} & {p}_{2 , 6} & {p}_{2 , 6} & {p}_{2 , 8} \\ {p}_{1 , 3} & {p}_{2 , 3} & {p}_{3 , 3} & {p}_{3 , 4} & {p}_{3 , 5} & {p}_{3 , 6} & {p}_{3 , 6} & {p}_{3 , 8} \\ {p}_{1 , 4} & {p}_{2 , 4} & {p}_{3 , 4} & {p}_{4 , 4} & {p}_{4 , 5} & {p}_{4 , 6} & {p}_{4 , 6} & {p}_{4 , 8}\end{matrix} )$$

The objective optimization problem may therefore be formulated as a minimization of the loss function ƒ(P), subject to an orthogonality constraint, PP^{T}=Iₘ and a binary constraint, (P_{i,j})∈{0,1}:

$${min}_{P} f ( P ) , subject to : {PP}^{T} = {I}_{m} ; and ( {P}_{i , j} ) ∈ \{ 0 , 1 \}$$

The skilled person will understand that imposing such constraints restricts the partial permutation P to the set of partial permutations [symbol] .

At step 206, a QUBO matrix Q suitable for implementing the objective optimization problem as a QUBO energy function is determined.

As discussed above, the QUBO formulation consists of the energy function

$$E ( x ) = {x}^{T} Q x$$

Wherein the QUBO matrix Q is a real and symmetric matrix and x is a vector having binary variables xᵢ.

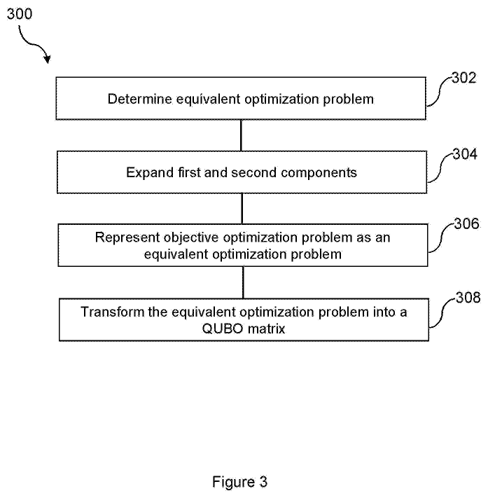

The QUBO matrix Q is determined following a QUBO matrix determination method 300, depicted in FIG. 3.

Herein the symbol ≅ will denote the relation of equivalence of the left hand side and right hand side expressions as objectives of a minimization problem. As an example, ag(x)+b≅cg(x) for all a,c>0, b∈ [symbol] , wherein g is an arbitrary function. That is, a problem having an objective ag(x)+b has the same solution as a problem having an objective cg(x).

At step 302 of the method 300, an equivalent optimization problem is determined by expanding the loss function ƒ(P) with the orthogonality and binary constraints being met, using the known definition of the Frobenius norm. The squared Frobenius norm for a matrix X with coefficients in [symbol] is defined as |X|_{F}²=tr(X^{T}X), wherein tr(⋅) is the matrix trace. The loss function ƒ(P) is expanded to:

$$\begin{matrix}f ( P ) = {\vert {PAP}^{T} - B \vert}_{F}^{2} \\ = T [ ( P {A}^{τ} {P}^{T} - {B}^{τ} ) \cdot ( {PAP}^{T} - B ) ] \\ = Tr [ ( P {A}^{T} {P}^{T} P A {P}^{T} - P {A}^{T} {P}^{T} B - {B}^{T} P A {P}^{T} + {B}^{T} B )\end{matrix}$$

$$\tilde{=} Tr ( P {A}^{T} {P}^{T} P A {P}^{T} ) - 2 T r ( {B}^{T} P A {P}^{T} )$$

Accordingly, the right hand side of the loss function ƒ(P) comprises a first component Tr(PA^{T}P^{T}PAP^{T}) and a second component Tr(B^{T}PAP^{T}).

The skilled person will understand that in the case where the first graph R and the second graph S comprise the same number of vertices, such that m=n, P^{T}P=PP^{T}=1. Accordingly, the term Tr(PA^{T}P^{T}PAP^{T})=Tr(A^{T}P^{T}PAP^{T}P)=Tr(A^{T}A)≅0. Therefore, the loss function ƒ(P) for the same number of vertex case is ƒ(P)≅−Tr(B^{T}PAP^{T}) and as such, the present problem becomes a graph isomorphism problem.

304, the first component and the second component are respectively expanded into vectorization operator formulations using a vectorization operator vec(⋅): [symbol] ( [symbol] )→ [symbol] ⊗ [symbol] . The vectorization operator vec(⋅) is configured to linearly transform a m×n matrix Z into a column vector, and is an isomorphism [symbol] ≅ [symbol] , defined as:

$${{v e c ( Z ) : = {\sum }_{i , j} {Z}_{i , j} \cdot \vert i 〉}_{m} ⊗ \vert j 〉}_{n}$$

Wherein Z_{i,j} is the entry of the matrix Z of row i, column j.

Accordingly, the vectorization operator covers the matrix A into a vector with columns stacked on each other. In particular, each row of the matrix A is converted into a corresponding column, which are subsequently concatenated. Using the second adjacency matrix B in the present example, the vectorization operator formulation is:

$$vec ( B ) = {[ 0 , 1 , 0 , 1 , 1 , 0 , 1 , 0 , 0 , 1 , 0 , 1 , 1 , 0 , 1 , 0 ]}^{T}$$

The skilled person will understand that the following identities for matrices A, B, C matrices (assuming the matrix multiplications A^{T}B and ABC are defined), are present:

$$tr ( {A}^{T} B ) = {vec ( A )}^{T} vec ( A ) = vec {( B )}^{T} vec ( A )$$

$$vec ( A B C ) = ( {C}^{T} ⊗ A ) vec ( B )$$

Accordingly, the first component tr(PA^{T}P^{T}PAP^{T}) of the loss function ƒ(P) may be expanded as:

$$\begin{matrix}tr ( {PA}^{T} {P}^{T} {PAP}^{T} ) = tr ( {( {PAP}^{T} )}^{T} {PAP}^{T} ) \\ = {vec ( {PAP}^{T} )}^{T} vec ( {PAP}^{T} ) \\ = {[ ( P ⊗ P ) vec ( A ) ]}^{T} ( P ⊗ P ) vec ( A ) \\ = {vec ( A )}^{T} ( {P}^{T} P ⊗ {P}^{T} P ) vec ( A )\end{matrix}$$

Furthermore, the second component tr(B^{T}PAP^{T}) of the loss function ƒ(P) may be expanded as:

$$\begin{matrix}tr ( {B}^{T} {PAP}^{T} ) = {vec ( B )}^{T} vec ( {PAP}^{T} ) \\ = {vec ( B )}^{T} ( P ⊗ P ) vec ( A )\end{matrix}$$

The skilled person will understand that the expanded first and second components are in quadratic forms. In particular, to illustrate the quadratic form, it shall be shown that the expression b^{T}Xa represents a quadratic form. Let X be an m×n matrix of element-wise quadratic forms, such that (X_{i,j})=y^{T}Q_{i,j}y for some symmetric matrices Q_{i,j} and some vector of binary variables y. The quadratic form x^{T}Qx is linear in Q, so for all a, b∈ [symbol] and Qᵢ∈Sₙ³, wherein Sₙ³ is the set of n×n symmetric matrices in [symbol] :

$${x}^{T} ( {aQ}_{a} + {bQ}_{a} ) x = {ax}^{T} {Q}_{a} x + {bx}^{T} {Q}_{b} x$$

The elements of X are:

$$X = ( \begin{matrix}{y}^{T} {Q}_{1 , 1} y & … & {y}^{T} {Q}_{1 , n} y \\ ⋮ & ⋱ & ⋮ \\ {y}^{T} {Q}_{m , 1} y & … & {y}^{T} {Q}_{m , n} y\end{matrix} )$$

Accordingly, by the linearity in Q_{i,j}:

$$\begin{matrix}{b}^{T} Xa = {\sum }_{i , j} ( {a}_{i} {y}^{T} {Q}_{i , j} {ya}_{j} ) \\ = {y}^{T} ( {\sum }_{i , j} ( {b}_{i} {a}_{j} {Q}_{i , j} ) ) y\end{matrix}$$

Therefore, since the linear combination of symmetric matrices Σ_{i,j}(bᵢaⱼQ_{i,j}) is also symmetric, b^{T}Xa corresponds to the structure of the QUBO energy function, x^{T}Qx.

Accordingly, the expanded first and second components, which have the form b^{T}Xa, are quadratic whenever P⊗P and P^{T}P⊗P^{T}P are matrices of element-wise quadratic forms under the constraints.

Then, for a∈ [symbol] , b∈ [symbol] , the expression b^{T}Xa represents a quadratic form. Accordingly, the expanded first and second components are quadratic forms whenever P⊗P and P^{T}P⊗P^{T}P are matrices of element-wise quadratic forms under the orthogonality and binary constraints.

Regarding the P⊗P term, element-wise quadratic forms are present because the entries are the degree 2 monomials:

$${( P ⊗ P )}_{i , j} = {p}_{{i}^{′} , {j}^{′}} \cdot {p}_{{i}^{″} , {j}^{″}}$$

Wherein i′=└i/m┘, j′=└j/n┘, i″=i mod m, and j″=j mod n.

Turning now to the P^{T}P⊗P^{T}P term, since P is a partial permutation matrix and P^{T}P=Iₘ, rank(PP^{T})=m=rank(P^{T}P). Accordingly, P^{T}P is a diagonal matrix and as such, P^{T}P⊗P^{T}P is diagonal. Since P^{T}P⊗P^{T}P is diagonal and the entries of vec(A) belong to [symbol] , the following is obtained:

$$\begin{matrix}{vec ( A )}^{T} ( {P}^{T} P ⊗ {P}^{T} P ) vec ( A ) = {vec ( A )}^{T} ( {P}^{T} P ⊗ {P}^{T} P ) vec ( A ) {1}_{{n}^{2}} \\ = {vec ( A )}^{T} ( {P}^{T} P ⊗ {P}^{T} P ) vec ( A ) ( {1}_{n} ⊗ {1}_{n} ) \\ = {vec ( A )}^{T} ( {P}^{T} P {1}_{n} ⊗ {P}^{T} P {1}_{n} ) \\ = {vec ( A )}^{T} ( {P}^{T} {1}_{m} ⊗ {P}^{T} {1}_{m} )\end{matrix}$$

Accordingly, the orthogonality and binary constraints cause the first component of the loss function ƒ(P) to reduce to vec(A)^{T}(P^{T}1ₘ⊗P^{T}1ₘ), which comprises products of linear forms and as such is a quadratic form. Accordingly, the expanded first and second components are quadratic forms.

At step 306, the objective optimization problem is represented as an equivalent optimization problem based on the vectorization operator formulations:

$${min}_{P} {vec ( A )}^{T} ( {P}^{T} {1}_{m} ⊗ {P}^{T} {1}_{m} ) - 2 \cdot {vec ( B )}^{T} ( P ⊗ P ) vec ( A ) ,$$

$$subject to : {PP}^{T} = {I}_{m} ; and$$

$$( {P}_{i , j} ) ∈ \{ 0 , 1 \}$$

Accordingly, the equivalent optimization problem represents a quadratic constrained quadratic problem for the sub-digraph isomorphism problem.

At step 308, the equivalent optimization problem is transformed into a QUBO matrix.

The skilled addressee will understand how to generate the objective optimization problem, for example following Glover, Fred: Kochenberger, Gary (2019). “A Tutorial on Formulating and Using QUBO Models”.

Turning back to the method 200, at step 208, a QUBO formulation including the QUBO matrix is solved on the quantum computer 140.

The skilled person will understand that if the first graph S and the second graph R comprise the same number of vertices, such that m=n, as is the case in the graph isomorphism problem, the equivalent optimization problem simplifies to:

$${min}_{P} - {vec ( B )}^{T} ( P ⊗ P ) vec ( A ) ,$$

$$subject to : {PP}^{T} = {I}_{m} ; and$$

$$( {P}_{i , j} ) ∈ \{ 0 , 1 \}$$

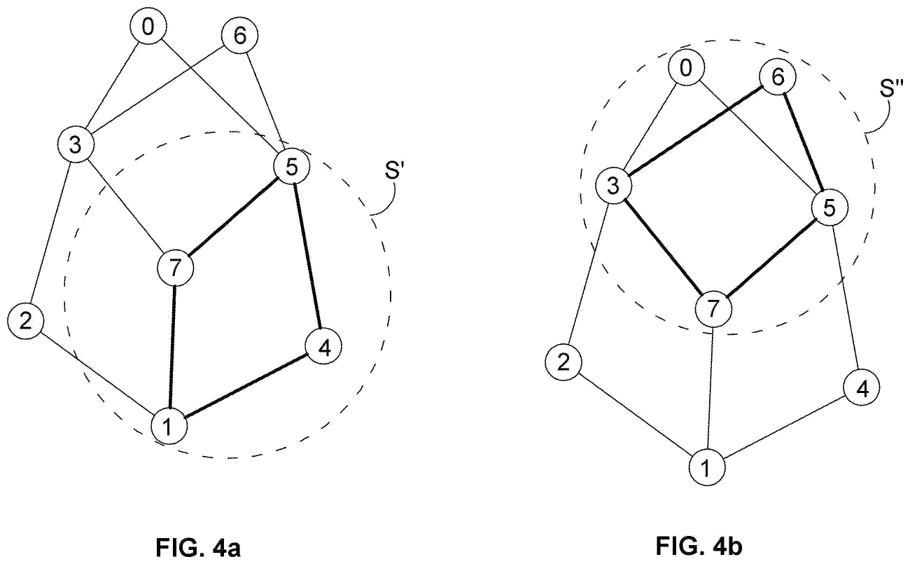

Examples solutions to the method 200 are shown in FIG. 4a and FIG. 4b. FIG. 4a shows a first subgraph section S′ of the first graph S which is isomorphic with the second graph R. FIG. 4b shows a second subgraph section S″ of the first graph S, which is also isomorphic with the second graph R. The subgraph sections S′, S″ each correspond to a distinct solution of the method 200 using the second graph R and the first graph S.

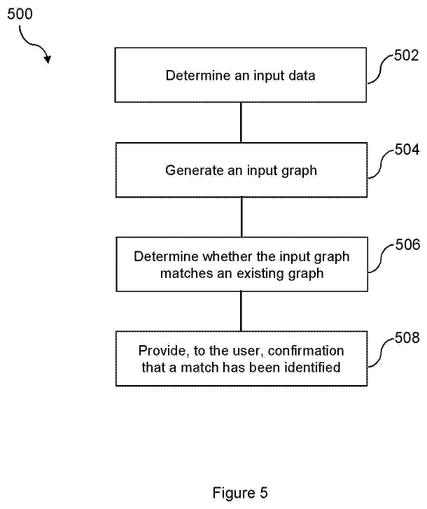

FIG. 5 depicts a method 500 for determining whether an input data matches an existing data stored in a database on the conventional memory 104 of the classical computer 130. In the present example, the input data is an input image, the existing data is an existing image, and the database is an image database.

The image database comprises a plurality of existing images that may have been previous input images, or an image downloaded from a third party source such as a third party server. The skilled person will understand that the existing images may have been acquired via any suitable means.

The conventional memory 104 comprises a graph library. The graph library comprises a plurality of existing graphs, each existing graph being associated with a respective existing image. The existing graphs each respectively comprise a set of nodes Vₑ (i.e. vertices) and a set of directed edges Eₛ connecting the nodes. The nodes and edges uniquely identify the corresponding existing image. The nodes correspond to respective pixels or sets of pixels of the corresponding existing image.

In a first step 502 of the method 500, the classical computer 130 receives an input image.

The input image may be, for example, a fingerprint image of a human fingerprint such that the method 500 determines whether the fingerprint image matches a fingerprint image stored in a fingerprint image database. Alternatively, the input image may be a facial image such that the method 500 determines whether the facial image matches a facial image in a facial image database. In a further alternative, the input image may be an integrated circuit layout such that the method 500 determines whether the integrated circuit layout corresponds to a circuit diagram of a circuit diagram database. In a further alternative, the input image may be an input financial transaction map and the existing images may instead be financial pattern templates. In this case, the method may identify that the input financial transaction map matches a financial pattern template, which may be indicative of unauthorised or unconventional transactions such as transactions associated with an instance of money laundering. The skilled person will appreciate that the method 500 may apply to any data that may be represented as a graph.

The input image may be acquired via an external imaging device in communication with the classical computer 130. Alternatively, the input image may be received from a third party server. The skilled person will understand that the input image may be received via any suitable means.

At step 504, the classical computer 130 generates an input graph representative of the input image. The input graph comprises a set of nodes Vᵢ (i.e. vertices) and a set of directed edges Et connecting the nodes. The nodes and edges uniquely identify the input image. The nodes may correspond to respective pixels or sets of pixels of the input image. The edges between vertices may represent a desired distance metric. The skilled person will understand that any suitable method may be used to generate the input graph corresponding to the input image, such as image segmentation.

At step 506, the classical computer 130 and the quantum computer 140 determine whether the input image matches an existing image. In particular, the method 200 is employed, with the second graph R being the input graph, and the first graph S being an existing graph of the set of existing graphs. If a sub-graph isomorphism is detected, then the input image matches the existing image corresponding to the existing graph.

Step 506 is repeated with a new existing graph of the set of existing graphs until a graph isomorphism is determined between a sub-graph of the existing graph and the input graph, or all of the existing graphs of the set of existing graphs have been. Alternatively, the method 200 may be repeated until a threshold number of graphs have been compared.

At step 508, the classical computer 130 provides, to the interface 110, confirmation that a match has been identified if a matching image has been determined in step 506, or a confirmation that no match has been identified if no matching image has been determined in step 506.

The objective optimization problem formulation obtained in step 306 may also be used to identify common induced subgraphs. The common induced subgraphs are induced subgraphs of both a first graph G and a second graph H. The first graph G and the second graph H comprise a large number of vertices, and the induced subgraph comprises m vertices.

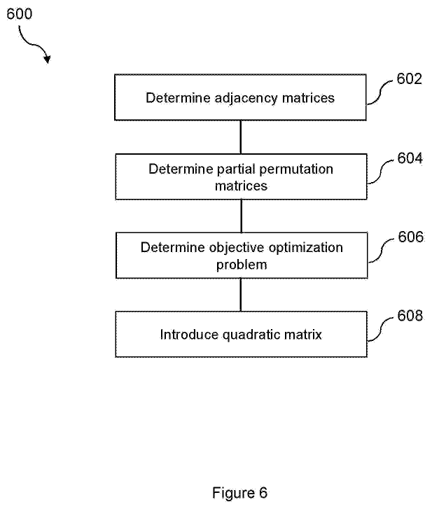

FIG. 6 provides a method 600 for determining or identifying common induced subgraphs of a first graph G and a second graph H. The first graph G and the second graph H are directed graphs, both having n vertices. This skilled person will understand that, as mentioned above, an induced subgraph comprises m vertices and as such, m<n.

In a first step 602, of the method 600, a first adjacency matrix A and a second adjacency matrix B are determined according to the adjacency matrix representation discussed in the “Adjacency Matrix Representation” section. The first adjacency matrix A corresponds to the first graph G and the second adjacency matrix B corresponds to the second graph H.

At step 604, a first partial permutation matrix P_{G} and a second partial permutation matrix P_{H} are determined, each being of matrix size m×n. The first partial permutation matrix P_{G} is associated with the first graph G and the second partial permutation matrix P_{H} is associated the second graph H.

The subgraph isomorphism problem solvable by the method 200 may be reinterpreted in the present context as a problem of identifying the graph resulting from applying the partial permutation P_{H} on the second graph B that is a subgraph of the first graph A.

Accordingly, at step 606, an objective optimization problem is determined. The objective optimization problem is similar to the equivalent objective optimization problem determined in step 306 of the method 300, but with a permuted adjacency matrix P_{H}BP_{H}^{T} of the second graph B, thereby obtaining:

$${min}_{{P}_{G} , {P}_{H} ∈ {ℳ}_{m , n} ( 𝔹 )} {vec ( A )}^{T} ( {P}_{G}^{T} {1}_{m} ⊗ {P}_{G}^{T} {1}_{m} ) - 2 \cdot {vec ( {P}_{H} {BP}_{H}^{T} )}^{T} ( {P}_{G} ⊗ {P}_{G} ) vec ( A ) ,$$

$$subject to : {P}_{G} {P}_{G}^{T} = {P}_{H} {P}_{H}^{T} = {I}_{m}$$

This skilled person will understand that vec(P_{G}BP_{G}^{T})=(P_{G}⊗P_{G})vec(B) and as such, the objective optimization problem may be formulated as:

$${min}_{{P}_{G} , {P}_{H} ∈ {ℳ}_{m , n} ( 𝔹 )} {vec ( A )}^{T} ( {P}_{G}^{T} {1}_{m} ⊗ {P}_{G}^{T} {1}_{m} ) - 2 \cdot {vec ( B )}^{T} ( {P}_{H}^{T} {P}_{G} ⊗ {P}_{H}^{T} {P}_{G} ) vec ( A ) ,$$

$$subject to : {P}_{G} {P}_{G}^{T} = {P}_{H} {P}_{H}^{T} = {I}_{m}$$

However, the skilled person will understand the expression P_{H}^{T}P_{G}⊗P_{H}^{T}P_{G} is a matrix of monomials having a degree greater than two, such that the objective optimization problem in the above formulation is not in a quadratic form suitable for solving.

Accordingly, at step 608, a quadratic matrix Q is introduced into the objective optimization problem, wherein the quadratic matrix Q is:

$$Q = {P}_{H}^{T} {P}_{G} ∈ {ℳ}_{n} ( 𝔹 )$$

Wherein [symbol] ( [symbol] ) is the set of n×n matrices in [symbol] , such that the entries are binary.

The quadratic matrix Q has a plurality of properties, including that QQ^{T} being a n×n diagonal matrix with binary entries, and Tr(QQ^{T})=m.

Accordingly, the objective optimization problem may be formulated as a quadratic problem with respect to the first partial permutation matrix P_{G} and the quadratic matrix Q:

$${min}_{{P}_{G} , {P}_{H} ∈ {ℳ}_{m , n} ( 𝔹 ) , Q {ℳ}_{n} ( 𝔹 )} {vec ( A )}^{T} ( {P}_{G}^{T} {1}_{m} ⊗ {P}_{G}^{T} {1}_{m} ) - 2 \cdot {vec ( B )}^{T} ( Q ⊗ Q ) vec ( A ) ,$$

$$subject to : {P}_{G} {P}_{G}^{T} = {I}_{m} ;$$

$${QQ}^{T} ∈ {𝒟}_{n} ( 𝔹 ) ; and$$

$$Tr ( {QQ}^{T} ) = m$$

The skilled person will understand that, since P_{G}P_{G}^{T}=Iₘ, QP_{G}^{T}=P_{H}^{T}P_{G}P_{G}^{T}, P_{H}=P_{G}Q^{T}.

Some embodiments may assign computer processing tasks to recipient processors, for example, but not limited to CPUs, GPUs, DSPs, GP-GPUs, quantum processor and/or processors optimised for artificial intelligence tasks. In such embodiments, the processors are the recipients and the processing tasks are the opportunities. In such embodiments, in for example, a complex cloud computing infrastructure a large number of tasks, of differing types, requiring execution may be received and a large number of processors may be housed within the cloud computing infrastructure.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the detailed description, numerous specific details are set forth to provide a thorough understanding of the disclosure provided herein. However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. The terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
determining, by a computer device, a first adjacency matrix of a first graph and a second adjacency matrix of a second graph, wherein the first graph comprises a greater number of vertices than the second graph;
determining, by the computer device, an objective optimization problem subject to one or more constraints, wherein the objective optimization problem is configured to determine a partial permutation matrix;
determining, by the computer device, a QUBO matrix suitable for implementing the objective optimization problem;
computing, by a quantum computer, a QUBO formulation including the QUBO matrix to generate the partial permutation matrix; and
applying, by the computer device, the partial permutation matrix to the first adjacency matrix to generate a partially permuted first adjacency matrix, wherein the partially permuted first adjacency matrix corresponds to a sub-graph of the first graph that is isomorphic with the second graph.

2. The method of claim 1, wherein the one or more constraints includes:
an orthogonality constraint configured to restrict the partial permutation matrix to being an orthogonal matrix; and
a binary constraint configured to restrict the entries of the partial permutation matrix to a 0 or a 1.

3. The method of claim 1, wherein the objective optimization problem is based on a loss function.

4. The method of claim 3, wherein the loss function is based on a Frobenius norm

5. The method of claim 4, wherein determining the QUBO matrix comprises:
converting the objective optimization problem into an equivalent optimization problem;
transforming the one or more constraints into one or more corresponding penalty terms; and
implementing the equivalent optimization problem and the one or more corresponding penalty terms as a QUBO problem.

6. The method of claim 5, wherein converting the objective optimization problem into an equivalent optimization problem comprises:
expanding the Frobenius norm subject to the constraints to generate a first component and a second component;
expanding the first component into a first vectorization operator formulation;
expanding the second component into a second vectorization operator formulation; and
generating the equivalent optimization problem based on the first and second vectorization operator formulations.

7. The method of claim 6, wherein the first and second vectorization operator formulations comprise one or more vectorization operators configured to linearly transform a matrix into a column vector.

8. The method of claim 1, wherein:
the objective optimization problem is based on a loss function, and
the partially permuted first adjacency matrix is obtained after the loss function vanishes.

9. A computer system, comprising:
one or more processors; and
a memory comprising a plurality of program instructions which, when executed by the one or more processors, cause the one or more processors to:
determine, by a computer device, a first adjacency matrix of a first graph and a second adjacency matrix of a second graph, wherein the first graph comprises a greater number of vertices than the second graph;
determine, by the computer device, an objective optimization problem subject to one or more constraints, wherein the objective optimization problem is configured to determine a partial permutation matrix;
determine, by the computer device, a QUBO matrix suitable for implementing the objective optimization problem;
compute, by a quantum computer, a QUBO formulation including the QUBO matrix to generate the partial permutation matrix; and
applying, by the computer device, the partial permutation matrix to the first adjacency matrix to generate a partially permuted first adjacency matrix, wherein the partially permuted first adjacency matrix corresponds to a sub-graph of the first graph that is isomorphic with the second graph.

10. A computer device, comprising:
one or more processors; and
a memory comprising a plurality of program instructions which, when executed by the one or more processors, cause the one or more processors to:
determine a first adjacency matrix of a first graph and a second adjacency matrix of a second graph, wherein the first graph comprises a greater number of vertices than the second graph;
determine an objective optimization problem subject to one or more constraints, wherein the objective optimization problem is configured to determine a partial permutation matrix;
determine a QUBO matrix suitable for implementing the objective optimization problem;
transmit the QUBO matrix to a quantum computer to generate the partial permutation matrix;
receive from the quantum computer the partial permutation matrix;
applying, by the computer device, the partial permutation matrix to the first adjacency matrix to generate a partially permuted first adjacency matrix, wherein the partially permuted first adjacency matrix corresponds to a sub-graph of the first graph that is isomorphic with the second graph.
